(19) United States
(12) Patent Application Publication
(10) Pub. No.: US 2003/0098334 A1
(43) Pub. Date: May 29, 2003

(54) Method for positioning and fixing components

(76) Inventor: Thomas Kuechen, Ingolstadt (DE)

Correspondence Address: FASSE PATENT ATTORNEYS, P.A., P.O. BOX 726, HAMPDEN, ME, 04444-0726, US

(21) Appl. No.: 10/009,159

(22) PCT Filed: Apr. 4, 2001
(86) PCT No.: PCT/EP01/03764

(30) Foreign Application Priority Data
Apr. 4, 2000 (DE) 100 16 717.9

(51) Int. Cl. B23K 31/02; B23K 20/12; B23P 11/00

(52) U.S. Cl. 228/112.1; 29/428; 228/2.1

(57) ABSTRACT

Prior receiving devices comprise a plate-shaped recess in the interior, into which a plastic part that is to be welded is laid. Since the dimensions of the laid-in plastic parts can vary, the plastic part can slip during the vibrational friction welding despite the pressure that has built up, thus worsening the welding duration and the welding result. The new receiving device is to reliably prevent the slipping of the plastic part.

To adapt the receiving device to the plastic part in a positive form-fitting manner, the receiving device comprises clamping jaws, between which the plastic part is clamped-in in a positive form-fitting manner during the build-up of the pressure.

A receiving device of this type is used predominantly for the closing of housings, in which sensitive electronic circuits, especially in the field of motor vehicle electronics, are arranged.

The invention relates to a method for the positioning and fixing of components.

In the vibrational friction welding of plastics, especially thermoplastic polymer materials, two plastic parts are rubbed against one another by an oscillating relative motion under pressure so long until the plastic melts and forms a homogeneous melt zone. After termination of the relative motion, the melt solidifies, and a joint seam arises. In order to fix the plastic parts on the vibrational friction welding device, for example, receiving devices are necessary. The receiving devices for lid-shaped plastic parts have previously been so constructed that they comprise a plate-shaped recess in the interior, into which a plastic part, for example the housing lid that is to be welded, is laid. Since the plastic parts do not always have exactly the same dimensions, but rather are subject to production tolerances, the recess must always be so dimensioned that even the plastic part with the largest acceptable dimension can be received in the recess. The tools also comprise so-called roughenings in the interior of the plate-shaped recesses, that is to say, the surface of the tool is characterized in such a manner so that the largest possible adhesion between the receiving device and the laid-in plastic part exists during the pressing together of the two plastic parts, in order to prevent an unintended sliding displacement or slipping of the plastic part in the receiving device during the weld-joining.

It is, however, disadvantageous in this method, that visible indentation or impression marks remain on the plastic surface due to the roughening of the tool. Due to the tolerance differences, the plastic parts cannot be exactly positioned, or centered in the case of round component shapes, in the recess of the receiving device. A following or sympathetic vibration of the plastic part within the fixed recess is unavoidable. From that, in turn, energy losses result, which has the effect that the welding durations become longer. Moreover, the size accuracy of the welded-together housing and the quality of the welded junction are worsened. A further disadvantage is that separate receiving devices must be used for different plastic parts. Also, plastic parts that embody a body of rotation can only be welded with difficulty with such a receiving device.

It is the object of the invention to provide a method for the positioning and fixing of components, with which especially the following or sympathetic vibration of the plastic part during the vibrational friction welding is prevented, and in which housing tolerances are compensated and housing parts are exactly positioned. A further object of the invention is to receive or take up various different plastic parts with one and the same receiving device, so that only one holder is used for various different plastic parts.

The object is achieved by the features in the characterizing portion of the patent claim 1. Therein, after the parts or components are laid into a first receiving device, this first receiving device and a second receiving device are pressed together, whereby the second receiving device comprises a mounting device and a clamping device, which are movably arranged relative to each other. Due to the contact pressure between the receiving devices, the mounting plate is moved relative to the clamping device, and this motion is converted by means of a transmission into a different motion, which operates the clamping device for the positioning and fixing of one part or component.

The advantages of the invention are that the tolerances that can arise during the manufacturing of the components are compensated. With this method, all components, even rotationally symmetrical ones, can be exactly positioned and fixed.

Advantageous further embodiments are defined by the dependent claims. In this context, a receiving device for carrying out the method is set forth. Which comprises a mounting plate and a clamping device, which are movably connected with one another, and which comprise a transmission. In this context, the transmission consists of a formed or molded wedge on the mounting plate and/or formed or molded wedge on the clamping jaw, so that the clamping jaw is moved along the formed wedge and is thereby clamped or tensioned during the pressing together of the mounting plate and the clamping jaw. Similarly, a guide pin arranged at an angle between the mounting plate and the clamping jaw can be used additionally or alone as the transmission. The guide pin is located in a guide bore or hole that is similarly arranged at an angle. A similarly advantageous further embodiment exists in the construction of the clamping device, which comprises a guide rail, on which one or more clamping jaws can be moved along. Also, the guide rail itself can form a contact or support surface, or a contact or support plate can be secured thereon. Furthermore, the advantageous use of the method or the receiving device in connection with the vibrational friction welding is set forth. Then, during the vibration, no energy losses arise due to a following or sympathetic vibration of the components. The welding durations are shortened and are no longer batch-related, i.e. dependent on the tool which was used for the manufacturing or production of the plastic part. A further advantage is given from the high positioning accuracy, for example of the lid over the housing. Also, the housing automatically opens itself when the welding pressure is removed. The welded-together plastic parts cannot remain stuck. Also, in the event of wear, the tool automatically compensatingly adjusts itself. A further advantage exists in that even rotationally symmetrical plastic parts are fixed in this receiving device in such a manner so that they can be similarly welded. Further, it is possible with such a construction, to receive or take up various different plastic parts with one and the same receiving device, so that it is no longer absolutely necessary that various different receiving devices must be used for various different plastic parts. Moreover, the welding durations are to be reduced, and the welding results are to be improved.

The invention shall be described in greater detail in the following, in connection with example embodiments and figures. Short description of the figures:

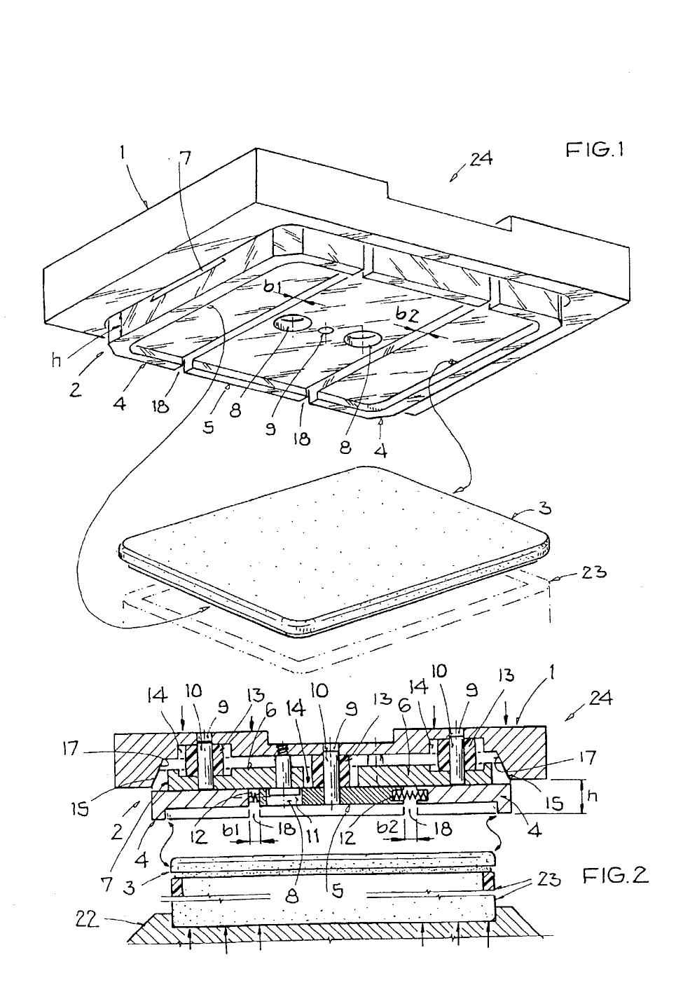

FIG. 1 receiving device for the vibrational friction welding with lid that is to be received.

FIG. 2 sectional view of a receiving device for the vibrational friction welding, in an unclamped or unstressed condition, with a formed wedge on the mounting plate.

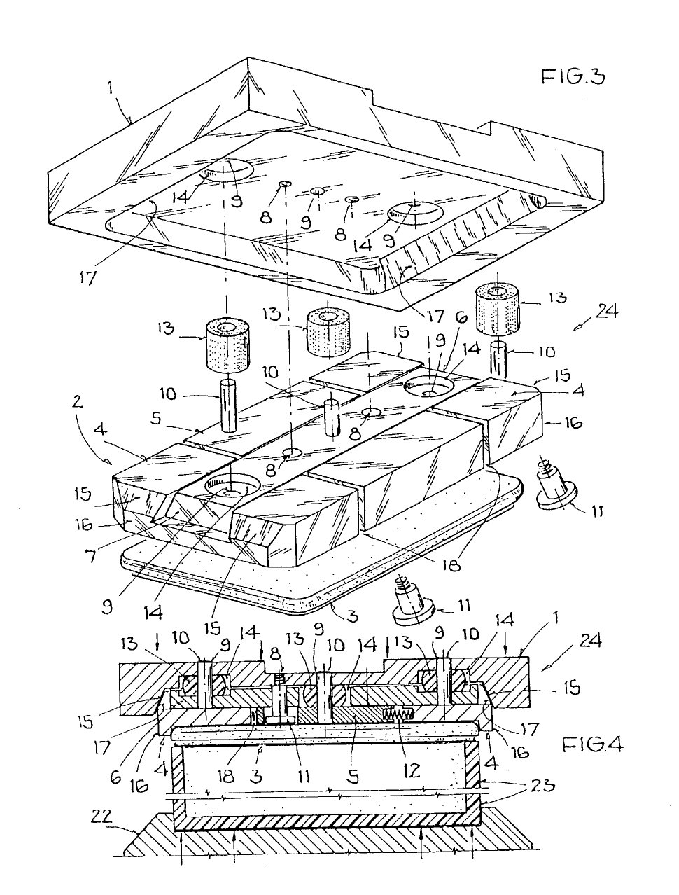

FIG. 3 components of a receiving device for the vibrational friction welding.

FIG. 4 sectional view of a receiving device for the vibrational friction welding, in the clamped or stressed condition, with a formed wedge on the mounting plate.

FIG. 5 sectional view of the components of the receiving device for the vibrational friction welding.

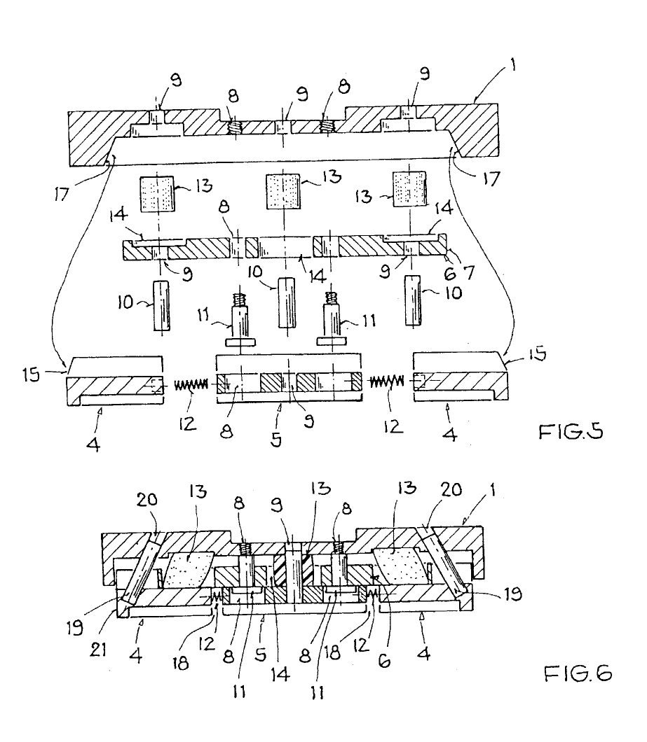

FIG. 6 sectional view of a receiving device for the vibrational friction welding in the unclamped or unstressed condition, with a guide pin inserted at an angle into an angled guide hole between mounting plate and clamping jaw.

FIG. 1 shows a receiving device for the vibrational friction welding with lid that is to be received or taken up. The receiving device essentially consists of a mounting plate 1 and a clamping device 2, which serves for the clamping of a plastic part 3, especially a lid. The clamping device 2 is partially arranged in the mounting plate 1, and particularly in such a manner that only a part with the remaining height h of the clamping device protrudes out of the mounting plate 1. The height h can be changed by means of pressing together the arrangement, since mounting plate 1 and clamping device 4 are arranged vertically movable relative to each other. The parts of the clamping device 2 that are visible in this view are the clamping jaws 4, in the middle of which a contact or support plate 5 is located. Between the contact plate and each clamping jaw, two gaps 18 are visible, of which the widths b₁ and b₂ are dependent on the height h. Furthermore, the contact plate comprises three bored holes 8, 9. In the two anchor screw holes 8 are located the anchor screws, which on the one hand are movably anchored with the clamping device 2, and on the other hand are rigidly screwed together with the mounting plate 1, so that the clamping device 2 can be moved into the bowl-shaped recess of the mounting plate 1. Between the two anchor screw holes 8, a guide hole 9 is visible, in which a guide pin is located, which restricts the possible motion between mounting plate 1 and clamping device 2 to one degree of freedom. That is to say, as an application example, the clamping device 2 can only be moved in a vertical direction toward or away from the mounting plate 1. When the clamping arrangement 2 moves in the vertical direction, thereby the clamping jaws 4 are moved in a horizontal direction by means of a transmission that is not visible in this view, whereby they can thereby fix and position a component.

FIG. 2 shows a sectional view through the receiving device 24, as shown in FIG. 1, in the unclamped or unstressed condition of the clamping jaws. The illustration of the pivot head arranged on the mounting plate 1 of the receiving device has been omitted. A further receiving device 22 with the plastic parts 3, 23 that are to be welded together is located under the receiving device 24. The upper receiving device 24 comprises a bowl-shaped mounting plate 1. This bowl-shaped mounting plate 1 comprises bored holes 8, 9 on the floor, which serve as a guide device and which have guide pins 10 and anchor pins 11 located therein, whereby the anchor pins 11 are rigidly connected at their thin end with the mounting plate 1, for example being screwed together therewith. The sidewall of the bowl-shaped mounting plate is at least partially angled or inclined on the inner surface of the side wall, so that the side wall inner surface at least partially forms a molded or formed wedge 17. In this context, the wall thickness increases in a direction toward the floor of the mounting plate 1. Pressure parts 13, which are embodied as rubber springs in the application example, are located on the floor of the mounting plate 1, concentrically around the vertical bored holes 8, 9, in which the guide pins 10 are arranged. A guide device 6 for the clamping jaws 4 is located on the rubber springs 13 in the interior of the bowl-shaped mounting plate 1. The guide device 6 in this application example is arranged as a guide rail, and is a component part of the clamping device 2. This guide rail 6 is loosely connected with the mounting plate 1 by the anchor pins 11. That is to say, mounting plate 1 and guide rail 6 are not screwed together with one another in a positive form-fitting manner, but rather comprise an interspace. Further guide holes 9 are arranged also in the guide rail 6, aligned or registered with the guide holes 9 in the floor of the mounting plate 1. Two clamping jaws 4 are arranged on the sides on the guide rail 6, by a positive form-fitting dovetail connection 7 that is not visible in this view. The two clamping jaws 4 can slide back and forth in the horizontal direction on the guide rail 6. Between the two clamping jaws 4 is located a plate 5, which serves to enlarge the contact surface for the lid 3, among other purposes. This contact plate 5 is similarly connected with the guide rail 6 by a dovetail connection that is not visible in this view. It comprises a further bored hole 9 aligned or in registration with the mounting plate 1 and the guide rail 6, and a guide pin 10 is inserted into this further bored hole 9, and serves to fix the contact plate 5 in the horizontal direction. Between the contact plate 5 and the two clamping jaws 4 there is respectively located a gap 18, with the width b₁ and b₂. Rubber springs 12 are located in these gaps 18. The two clamping jaws 4 and the contact plate 5 form the clamping device 2, in which later the lid 3 to be welded together with the cup 23 will be located, which in turn are arranged in a different receiving device 22.

FIG. 3 shows the component parts of the receiving device 24 for the vibrational friction welding. The bowl-shaped mounting plate 1 is illustrated at the top. This bowl-shaped mounting plate 1 comprises assembly or mounting devices, which serve to secure the receiving device on a vibration head, with which the vibration for the welding is generated. These assembly or mounting devices are, however, not shown in detail in the illustrations. Similarly in the floor, there are located bored holes 8, 9, which serve as a guide device for the guide pins 10 and in which the anchor screws 11 are arranged, whereby the anchor screws 11 are rigidly connected at their thin end with the mounting plate 1, as already shown in FIG. 2. The side wall of the bowl-shaped mounting plate 1 is at least partially angled or inclined on the inner surface of the side wall, so that the side wall inner surface forms a formed or molded wedge 17. The wall thickness increases in a direction toward the floor of the mounting plate. Pressure parts 13, which are embodied as rubber springs in the application example, are located on the floor of the mounting plate 1 concentrically around the vertical bored holes, in which the guide pins 10 are arranged. A guide device 6 for the clamping jaws 4 is located on the rubber springs 13 in the interior of the bowl-shaped mounting plate. The guide device 6 in this application example is arranged as a guide rail. This guide rail 6 is connected with the mounting plate 1 by the anchor screws 11. However, the mounting plate 1 and guide rail 6 are not screwed together with each other in a positive form-fitting manner, but rather comprise an interspace. Further guide holes 9 are arranged also in the guide rail 6, aligned or in registration with the guide holes 9 in the floor of the mounting plate 1. The guide rail 6 is embodied with a dovetail shape. Two clamping jaws 4 are arranged on the sides of the guide rails 6 by means of a positive form-fitting dovetail connection 7. The two clamping jaws 4 can slide back and forth in a horizontal direction on the guide rail 6. Between the two clamping jaws 4 there is located a plate 5, which serves to enlarge the contact surface for the plastic part 3, among other functions. This contact plate 5 is similarly connected with the guide rail 6 by means of a dovetail connection 7, however, it comprises bored holes 9 aligned or in registration with the mounting plate 1 and the guide rail 6, into which the guide pins 10 are inserted and which serve to fix the contact plate 5 in a horizontal direction. A gap 18 is respectively located between the contact plate 5 and the two clamping jaws 4. In this gap there are located rubber springs 12, which are not visible in this view. The guide rail 6, the two clamping jaws 4 and the contact plate 5 form the clamping device 2, in which the plastic part 3 will later be located during the vibrational friction welding. By means of the movable clamping jaws 4, the plastic part 3 can be clamped into the clamping device 2. The formed or molded wedge 17 on the mounting plate 1 and the formed or molded wedge 15 on the edge or end face of a clamping jaw 4 form a wedge transmission, which converts the vertical movement of the clamping jaw 4 in the mounting plate 1 into a horizontal movement of the clamping jaw 4. However, one formed or molded wedge is sufficient for the wedge transmission. The edges or end faces 16 of the clamping jaws 4 can also extend straight.

If now, as shown in FIG. 4, the contact pressure between the two receiving devices 22, 24 is built-up or increased, then the lid 3 will be moved upwardly with the clamping device 2 against the smaller pressure forces of the rubber springs 13. The clamping device 2 with the lid 3 is moved parallel to the housing 23. The sloping plane 17 on the mounting plate 1 or on the clamping device 15 effectuate a clamping movement, which fixes the lid 3. The tension clamping or stress is limited by the lid 3. During the opening of the receiving devices 22, 24, the pressure parts 13 expand, and the clamping jaws 4 are opened along the sloping plane. The vertical motion and therewith the opening of the clamping jaws 4 can be adjusted by the anchor screws 11. FIG. 4 shows the sectional view of the receiving device 24 for the vibrational friction welding, with formed or molded wedge on the mounting plate 1 in the clamped or stressed condition, that is to say, the welding pressure between the two above-mentioned plastic parts is at least partially developed. If pressure is exerted onto the lid 3 on the bottom side of the receiving device, then the rubber springs 13, of which the force or strength is smaller than the applied welding force, and which are located between the mounting plate 1 and the guide rail 6 or the contact plate 5, are pressed together. The vertically movably supported guide rail 6, with the clamping jaws 4 and the contact plate 5, moves upwardly along the guide pins 10 and the anchor screws 11, so long until they contact against the mounting plate 1, or the stressed spring rubbers 13 or another device exert the corresponding counterforce. If the clamping jaws 4, or their wedge-shaped edge or end face surfaces 15 come into the molded or formed wedge 17 of the side walls of the mounting plate 1, due to the pressure-forced vertical motion, thereby the clamping jaws 4 are pressed together until the lid 3 is enclosed by the clamping jaws 4 in a positive form-fitting manner. The formed or molded wedge 17 and the wedge-shaped extending edge or end face 15 represent a wedge transmission, which converts a vertical motion into a horizontal motion. In this context it is not essential whether the wedge transmission comprises one or more formed or molded wedges, which are for example arranged in the form of a sloping inner or outer side wall on the mounting plate 1 or on the clamping jaws 4 or on the mounting plate 1 and the clamping jaws 4.

FIG. 5 shows a sectional view of the component parts of the receiving device for the vibrational friction welding. At the top, the receiving device comprises a bowl-shaped mounting plate 1. This bowl-shaped mounting plate 1 on the floor comprises bored holes 8, 9, which serve as guide device and in which are located guide pins 10 and anchor pins 11, whereby the anchor pins 11 at their thin end are rigidly connected, for example screwed together, with the mounting plate 1. The side wall of the bowl-shaped mounting plate is at least partially sloped on the inner surface of the side wall, so that the side wall inner surface at least partially embodies a formed or molded wedge 17. In this context, the wall thickness increases in a direction toward the floor of the mounting plate 1. Pressure parts 13, which are embodied as rubber springs in the application example, are located on the floor of the mounting plate 1 concentrically around the vertical bored holes 8, 9 in which the guide pins 10 are arranged. A guide device 6 is located on the rubber springs 13 in the interior of the bowl-shaped mounting plate 1. The guide device 6 in this application example is arranged as guide rail, and is a component part of the clamping device 2. This guide rail 6 is loosely connected with the mounting plate 1 by the anchor pins 11. That is to say, mounting plate 1 and guide rail 6 are not screwed together with each other in a positive form-fitting manner, but rather comprise an interspace. Further guide holes 9 are also arranged in the guide rail 6 in alignment or registration with the guide holes 10 in the floor of the mounting plate 1. The guide rail 6 is constructed with a dovetail shape on the sides. The two clamping jaws 4 with a dove-tail shaped recess can slide back and forth in the horizontal direction on the dovetail shaped guide rail 6. Between the two clamping jaws 4 there is located a plate 5, which serves to enlarge the contact surface for the lid 3, among other functions. This contact plate 5 is similarly connected with the guide rail 6 by a dovetail connection that is not visible in this illustration. It comprises a further bored hole 9, in alignment or registration with the mounting plate 1 and the guide rail 6, into which a guide pin 10 is inserted, and which serves to fix the contact plate 5 in a horizontal direction. Springs 12, between the contact plate 5 and the two clamping jaws 4, which press apart the clamping jaws. The guide rail, the two clamping jaws 4 and the contact plate 5 form the clamping device 2, in which the lid is clamped for the welding.

In all of the preceding application examples, it is without significance, whether the molded or formed wedges 17, 15 are located on the mounting plate 1 or on the clamping jaws 4 or on the clamping jaws and on the mounting plate. Furthermore, the wedge-shape can take on various different shapes that are also not continuously extending, in order to vary the dependence of the welding pressure and the clamping tension of the clamping jaws.

FIG. 6 shows a sectional view of a receiving device for the vibrational friction welding, in the unclamped or unstressed condition, with obliquely inserted guide pins 19 in an inclined guide hole 20 between mounting plate 1 and clamping jaw 4. In this illustration, the wedge transmission consists of an obliquely guided guide pin 19. The guide pin 19 or the guide pins 19 are hereby secured on the side of the clamping jaw 4, and particularly in such a manner that they extend at an angle or obliquely in the direction of the mounting plate 1. An angled guide hole 20 is located in the mounting plate 1, and particularly in extension of the obliquely inserted guide pin 19. If now a vertical pressure is exerted on the clamping jaws 4, that is to say, if a plastic part such as, for example, a lid, which is located between the clamping jaws 4, is pressed against another plastic part 4, then the guide pin 19 with the clamping jaw 4 will move along the sloping or angled guide hole 20. Due to the sloping or angled arrangement of the guide pins 19 and guide pin holes 20, the clamping jaws 4, which simultaneously move along the dovetail shaped guide rail 6 in connection with being pressed together, are pressed together. The oblique or angled guide pins 19 do not extend within the guide rail 6. This is guided in the direction of the mounting plate 1 by means of vertical guide 10 and anchor pins 11 as in the previous examples. With this type of wedge transmission it is advantageous, that the pressure parts 13, which are located on the side and on which shear forces are effective, are similarly arranged obliquely or at an angle. Similarly, the formed or molded wedge is omitted from the mounting plate 1 and the edge or end face 21 of the clamping jaw 4 extends linearly.

Also a plurality of the various different wedge transmissions can be utilized together in a holder. Moreover, the number of the clamping jaws can be increased as desired, in that the guide rail, for example, is shaped with a star-shape or the receiving device comprises plural guide rails in various different directions, so that also unsymmetrical plastic parts can be exactly fixed. Similarly, the dovetail connection between clamping jaw and guide rail is not necessarily required, but rather the horizontally movable but vertically rigid connection can also be produced by other connection configurations.

1. Method for the positioning and fixing of a first component (3) relative to a second component (23), in that following method steps are carried out:
a) laying of the first and second components (3, 23) in a first receiving device (22),
b) moving of the first receiving device (22) against a second receiving device (24) or vice versa, whereby the second receiving device (24) comprises a mounting plate (1) and a clamping device (2), which are arranged movably relative to each other, and developing of a contact pressure between the two receiving devices (22, 24) through the components (3, 23),
c) grasping of the first component (3) by means of the clamping device (2) during the movement of the mounting plate (1) due to the contact pressure, and generation of a clamping movement for the positioning and fixing of the first component (3) by means of at least one transmission, which converts the movement of the receiving device into the clamping movement.

2. Receiving device (24) for carrying out a method according to patent claim 1, characterized in that the second receiving device (24) comprises the following component parts:
the mounting plate (1),
the clamping device (2), which comprises movably supported clamping jaws (4), between which the first component (3) is clamped-in, during the developing of the contact pressure, whereby
the clamping device (2) is movably connected with the mounting plate (1) and
the clamping device (2) and the mounting plate (1) approach each other during the developing of the contact pressure, and
the transmission, especially wedge transmission, which converts the movement between mounting plate (1) and clamping device (2) into a clamping movement of the clamping jaws (4).

3. Receiving device (24) according to patent claim 2, characterized in that the transmission comprises a formed wedge (17) on the side wall of the bowl-shaped mounting plate (1), on which at least one clamping jaw (4) moves along.

4. Receiving device (24) according to patent claim 2, characterized in that the transmission comprises a formed wedge (15) on at least one clamping jaw (4) and this formed wedge (15) is moved along on the side wall (17) of the bowl-shaped mounting plate (1) or the side wall (17) is moved along the formed wedge (15).

5. Receiving device (24) according to patent claim 2, characterized in that the transmission comprises at least one guide pin (19) that is inserted obliquely between one clamping jaw (4) and the mounting plate (1) in an obliquely extending guide hole (20), with which the clamping jaw (4) is moved.

6. Receiving device (24) according to one of the patent claims 2 to 5, characterized in that the clamping device (2) consists of at least
one contact plate (5), on which the component (3) to be clamped rests against,
one clamping jaw (4), in which the component (3) is clamped, and
one guide rail (6), on which the clamping jaw (4) moves along.

7. Receiving device (24) according to one of the patent claims 2 to 5, characterized in that the clamping device (2) consists of at least
one guide rail (6), which forms a contact plate on which the component (3) to be clamped-in rests, and
one clamping jaw (4) with which the plastic part (3) is clamped-in, and which moves along the guide rail (6).

8. Use for a method according to patent claim 1, characterized in that the receiving devices (22, 24) are used for vibrational friction welding, whereby the two components (3, 23) are rubbed against one another so long until the two components (3, 23) melt.

9. Use for a receiving device (24) according to patent claim 2, characterized in that the receiving device (24) is a component part of a vibrational friction welding apparatus, and the mounting plate (1) is connected with a vibration unit.

10. Use for a method according to patent claim 1, characterized in that the receiving devices (22, 24) are used for vibrational or rotational welding, whereby the two components (3, 23) are moved against each other so long until the two components (3, 23) melt.

11. Use for a receiving device (24) according to patent claim 2, characterized in that the receiving device (24) is a component part of a vibrational or rotational welding apparatus, and the mounting plate (1) is connected with a vibration or rotation unit.
